(19) United States
(12) Patent Application Publication
(10) Pub. No.: US 2010/0158091 A1
(43) Pub. Date: Jun. 24, 2010

(54) FREQUENCY ERROR ESTIMATOR AND FREQUENCY ERROR ESTIMATING METHOD THEREOF

(75) Inventors: Pan-Soo Kim, Daejeon (KR); Joon-Gyu Ryu, Daejeon (KR); Dae-Ig Chang, Daejeon (KR); Ho-Jin Lee, Daejeon (KR); Myung-Hoon Sunwoo, Gyeonggi-do (KR); Jang-Woong Park, Gyeonggi-do (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/496,917

(22) Filed: Jul. 2, 2009

(30) Foreign Application Priority Data
Dec. 22, 2008 (KR) 10-2008-0131645

(51) Int. Cl. H04B 17/00; H04L 27/06

(52) U.S. Cl. 375/226; 375/340

(57) ABSTRACT

Provided is a frequency error estimating method of a communication system. The method includes receiving a frame, and calculating a frequency error from a SOF field of the received frame.

### CROSS-REFERENCE TO RELATED APPLICATIONS

This U.S. non-provisional patent application claims priority under 35 U.S.C. §119 of Korean Patent Application No. 10-2008-0131645, filed on Dec. 22, 2008, the entire contents of which are hereby incorporated by reference.

### BACKGROUND OF THE INVENTION

The present invention disclosed herein relates to a frequency error estimator and a frequency error estimating method thereof.

A typical digital video broadcasting via satellite (DVB-S) standard, developed in Europe, is a satellite digital video broadcasting standard that is extensively used in current satellite broadcasting of each station. The DVB-S utilizes only a quadrature phase shift keying (QPSK) method. If a modulation method is fixed with the above QPSK method, transmission efficiency is deteriorated because data are transmitted less than actual transmittable data amount even when a channel state is excellent.

A digital video broadcasting via satellite, second generation (DVB-S2) standard that improves frequency efficiency from the typical DVB-S standard was completed in 2003, and makes it possible to provide high transmission efficiency and highly reliable transmission in the same environment as a DVB-S system. Additionally, the DVB-S2 standard uses a low-density parity check (LDPC) code, which is a string error correction code, and employs a high level modulation method of 16/32 amplitude and phase-shift keying (APSK), to increase frequency efficiency of about 30% compared to the typical DVB-S standard.

In a system employing a modulation method such as phase-shift keying (PSK), accurate estimation of carrier frequency offset is a very important issue. The DVB-S2 system causes a great deal of carrier frequency errors because of the same frequency error environment as the DVB-S system and usage of a low-priced oscillating circuit for commercial mass production. Additionally, a carrier frequency estimator becomes more complex to estimate the above carrier frequency errors compared to the typical DVB-S system.

### SUMMARY OF THE INVENTION

The present invention provides a frequency error estimating method that uses a data-aided frequency estimation algorithm in order to estimate an initial frequency error efficiently in a DVB-S2 system, and a circuit for executing the frequency error estimating method.

Embodiments of the present invention provide frequency error estimating methods of a communication system include: receiving a frame; and calculating a frequency error from a start of frame (SOF) field of the received frame.

In some embodiments, the frequency error is calculated while a physical layer header of the frame is received.

In other embodiments, the calculating of the frequency error includes: multiplying a plurality of symbols of the SOF field by training symbols for estimating errors in order for outputting result values; calculating each autocorrelation value from the outputted result values; calculating phase differences between adjacent symbols from the calculated autocorrelation value; and calculating frequency errors from the calculated phase differences.

In still other embodiments, the calculating of the frequency error uses a data-aided algorithm.

In even other embodiments, the frame is set by a digital video broadcasting via satellite, second generation (DVB-S2) standard.

In other embodiments of the present invention, frequency error estimators include: a first-in-first-out (FIFO) memory storing values obtained by multiplying a plurality of SOF symbols in a received frame by training symbols used for estimating errors; a tap delay outputting the values stored in the FIFO memory according to scheduling in synchronization with a first clock and storing the outputted values in first registers; a plurality of autocorrelators outputting the values stored in the first registers in synchronization with a second clock, and calculating autocorrelation value from the outputted values; second registers storing the calculated autocorrelation value; a phase difference calculation block calculating a phase difference between adjacent symbols from the values stored in the second registers; and an adder calculating a frequency error by adding the calculated phase differences.

In some embodiments, the number of the SOF symbols is 26, and the number of the first registers is 11.

In other embodiments, the number of the autocorrelators is 4.

In still other embodiments, the frequency error is calculated until a physical layer symbol of the received frame is received.

In even other embodiments, the received frame is a frame set by a DVB-S2.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a view illustrating a satellite communication system according to an embodiment of the present invention;

FIG. 2 is a view illustrating a frame structure defined in the DVB-S2 standard;

FIG. 3 is a view illustrating an estimation method using a pilot block in a typical frequency estimator;

FIG. 4 is a view illustrating a typical frequency estimator using an M&M algorithm;

FIG. 5 is a view illustrating an initial frequency error estimator based on an M&M algorithm according to an embodiment of the present invention;

FIG. 6 is a view illustrating scheduling of a signal according to an embodiment of the present invention;

FIG. 7 is a table illustrating performance comparison between a typical frequency estimator and a frequency estimator of the present invention; and

FIG. 8 is a flowchart illustrating a frequency synchronization method according to the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

A communication system according to the present invention includes a frequency estimator configured to use start of frame (SOF) during initial frequency error estimation. Therefore, the frequency estimator of the present invention secures relatively sufficient time during frequency estimation compared to a typical one, and thus its hardware complexity can be reduced.

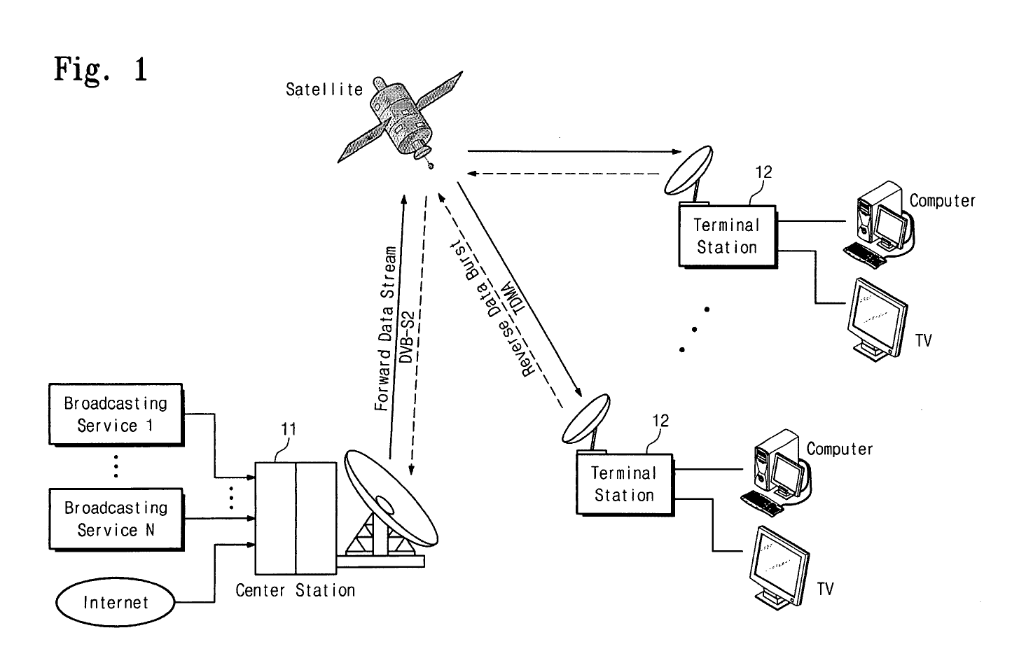

FIG. 1 is a view illustrating a satellite communication system according to an embodiment of the present invention. Referring to FIG. 1, a satellite system 10 includes a center station 11 and a plurality of terminal stations 12. The center station 11 is configured to estimate frequency through the SOF during an operation for receiving a frame from a satellite through a DVB-S2 method.

The center station 11 includes a center station transmission unit and a center station reception unit. The center station transmission unit receives various kinds of MPEG2-TS packets for broadcasting from the external and two-way communication and receives multiple input in the DVB-S2 method and then transmits it to a forward direction link of an ACM mode using respectively different protection degrees with respect to each input stream. The center station reception unit receives a signal inputted from the terminal station 12 to a reverse direction link of a TDMA-based DVB-RCS method and performs a demodulating/decoding function.

Here, the center station 11 is connected to the internet to provide the two-way communication. The center station 11 has functions receiving a plurality of broadcasting streams for providing a broadcasting service, a DVB-S2/RCS PSI/SI table that all terminals must receive, and MPEG2-TS packets where an NCR value is inserted for obtaining and maintaining network synchronization, from a mode and stream application unit of a DVB-S2 ACM modulator, transmitting them after granting different protection degrees with respect to each input stream like each channel coding and modulating method, and demodulating the signal transmitted from a receiving terminal station for restoration.

The terminal station 12 receives a signal transmitted from the center station 11 via a forward direction link, and transmits data via a reverse direction link. Additionally, a plurality of terminal stations 12 receives two-way satellite communication service transmitted from the center station 11.

The center station 11 in the two-way satellite communication system 10 of the present invention estimates frequency errors through the SOF during the receiving of frames from the satellite. Therefore, according to the center station 11 of the present invention, hardware complexity required for estimating frequency error can be reduced.

In FIG. 1, communication is performed through the DVB-S2 method between the satellite and the center station 11, and through the TDMA method between the satellite and the terminal station 12. However, the satellite communication system of the present invention does not need to be limited thereto. The satellite communication system 10 performs communication through the DVB-S2 between the satellite and the terminal station 12.

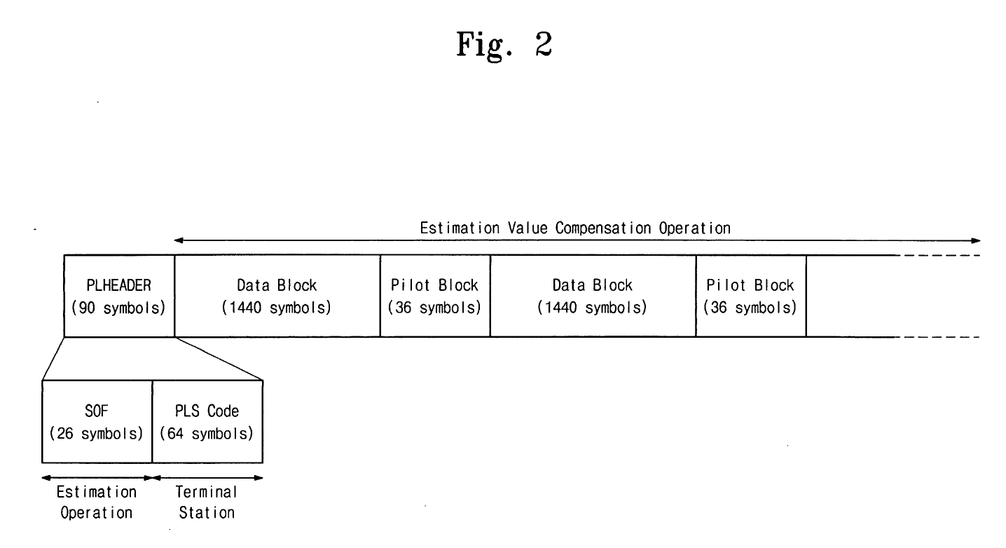

FIG. 2 is a view illustrating a frame structure defined in the DVB-S2 standard. Referring to FIG. 2, a frame includes a physical layer header (PLHEADER) and a forward error correction (FEC) frame with a plurality of pairs of a data block and pilot block.

The PLHEADER includes SOF of 26 symbols and physical layer signaling code (PLSC) of 64 symbols. The SOF is used in a receiver for synchronizing a transmitted synchronization frame and indicates the start of a frame. The SOF is constant regardless of a modulation method and a code rate. The PLSC includes MODCOD 5 providing modulation method and code rate information and TYPE 2 providing the length of a frame block and whether there is pilot information or not. According to the present invention, frequency error is estimated through the SOF.

The FEC frame includes a pilot block of 36 symbols that is repeated by each data block of 1440 symbols. In the pilot block of 36 symbols, BCH external coding and LDPC inner encoding for error correction are performed to add a parity.

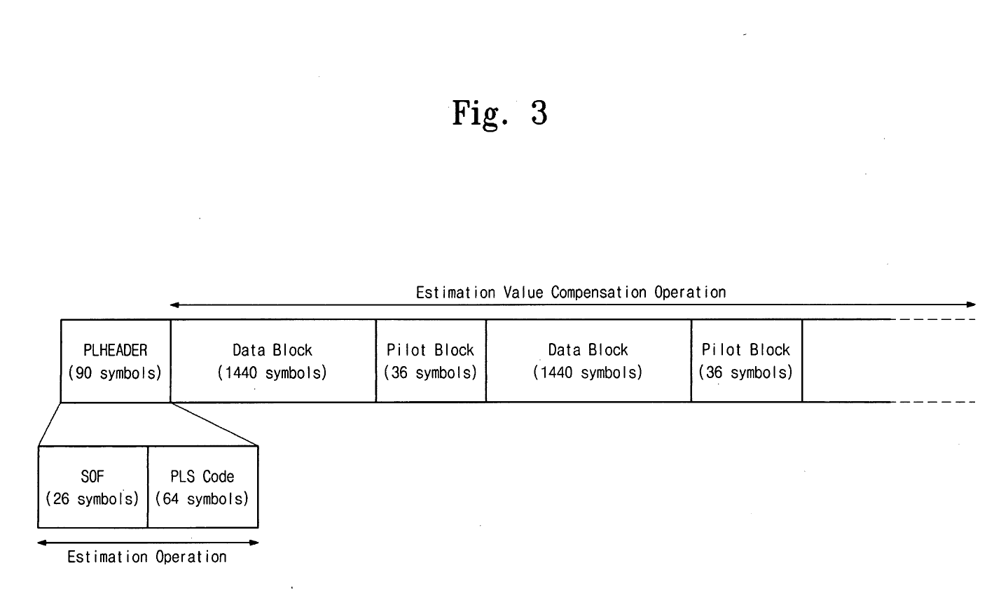

A frequency estimator of a typical communication system estimates frequency error through a pilot block. FIG. 3 is a view illustrating an estimation method using a pilot block in a typical frequency estimator. Referring to FIG. 3, the frequency estimator estimates frequency error at each pilot interval, and updates an estimation value in the next data interval. In this case, a necessary time for performing estimation calculation is short. Due to this, the typical frequency estimator has a high hardware complexity.

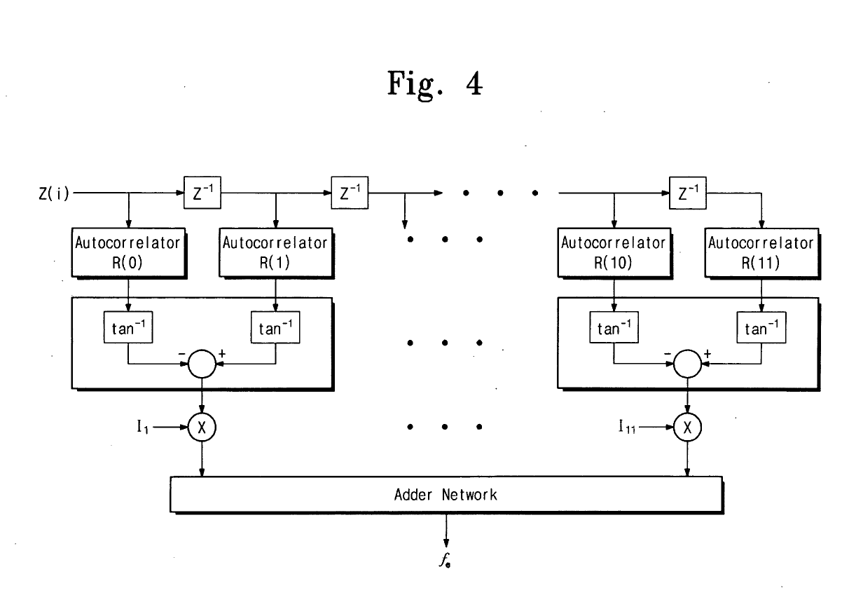

FIG. 4 is a view illustrating a typical frequency estimator using an M&M algorithm. Referring to FIG. 4, the frequency estimator requires high hardware complexity because the number of autocorrelators and arctangent operators is increased to estimate a frequency error at each pilot interval.

On the contrary, a frequency error estimating operation is performed during a physical layer header interval through SOF, such that an operation time for estimation can be sufficiently obtained. Due to this, the frequency estimator of the present invention reduces the number of autocorrelators and arctangent operators such that hardware complexity can be minimized.

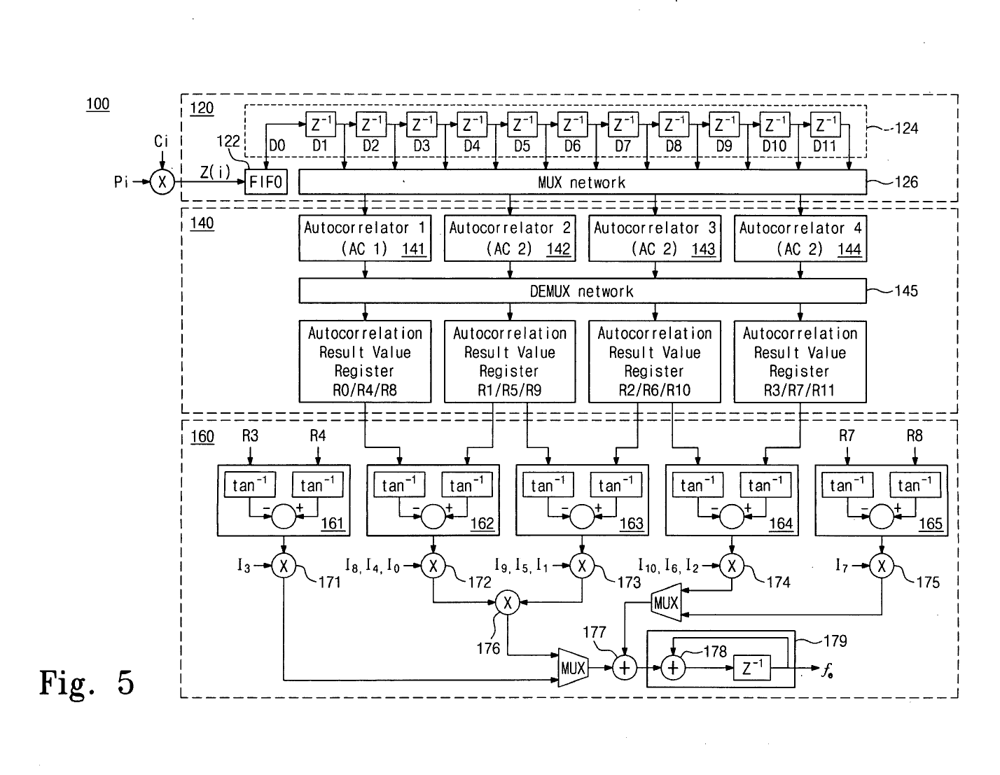

FIG. 5 is a view illustrating an initial frequency error estimator 100 based on an M&M algorithm according to an embodiment of the present invention. Referring to FIG. 5, the frequency error estimator 100 includes a first unit 120, a second unit 140, and a third unit 160.

The first unit 120 includes a first-in-first-out (FIFO) 122, a tap delay 124, and a MUX network 126.

The FIFO 122 has the size of 52 bytes (26 bit*16 bit) and stores a value Z(i) as shown in Equation (1). The value Z(i) is obtained by multiplying a training symbol cᵢ by transmitted 26 SOF symbols pᵢ. The training symbol cᵢ is an i^{th} symbol for frequency estimation.

Z(i)=pᵢc*ᵢ,i=0, 1, . . . 26 (1)

Values stored in the FIFO 122 are transferred to the tap delay 124 through a control signal during a predetermined time.

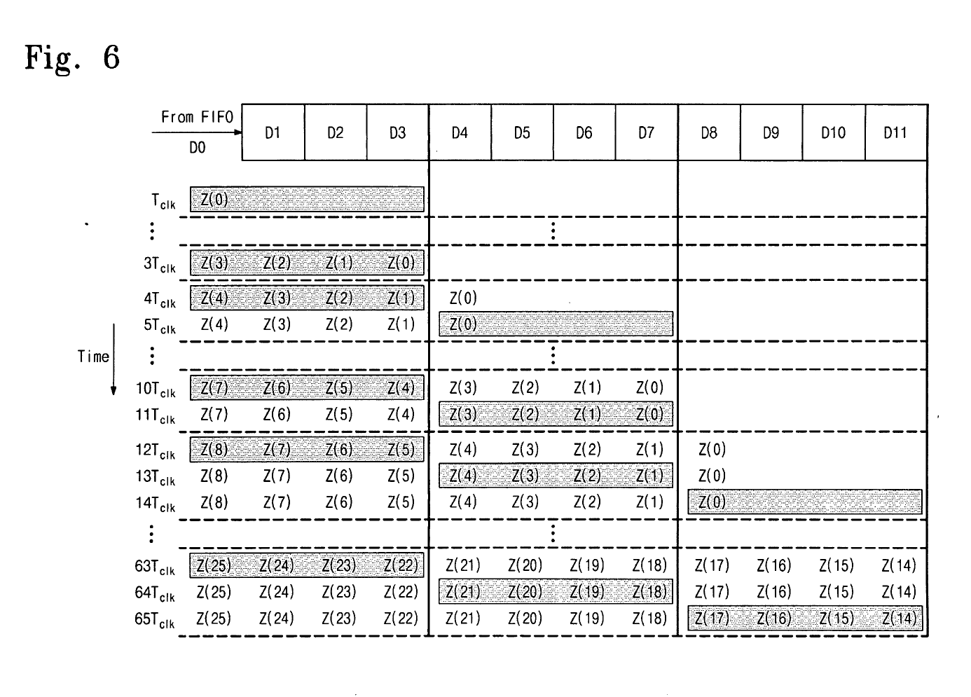

The tap delay 124 includes 11 registers and each of them has the size of 16 bits. The values transmitted in the tap delay 124 are outputted from each of the registers D0 to D11 according to scheduling. More detailed description will be made with reference to FIG. 6. At this point, the values outputted from registers are transmitted to each of the autocorrelators 141, 142, 143, and 144 via the MUX network 126.

For example, each of the registers D0 to D11 in the tap delay 124 performs a shift operation by each 2T_{clk} during 4T_{clk} to 11T_{clk}. During one T_{clk} of each 2T_{clk}, the output D0 of the FIFO 122 and outputs of the registers D1, D2, and D3 are delivered to an input of each of the autocorrelator 141, 142, 143, and 144. During the remaining T_{clk}, outputs of the registers D4, D5, and D6 are delivered to an input of each of the autocorrelators 141, 142, 143, and 144.

The second unit 140 includes four autocorrelators 141, 142, 143, and 144, a DEMUX network 145, and 12 registers R0 to R11 storing an autocorrelation result value.

A detailed operation of the second unit 140 will be described with reference to Equation (2).

$$\begin{matrix} From {T}_{clk} to 3 {T}_{clk} \text{:} m \text{?} n = 1 \text{?} 2 \text{?} 3 \text{?} 4 \text{?} & ( 2 ) \\ ACn \text{:} R ( n - 1 ) = {\sum }_{i = 0}^{3} \frac{1}{{L}_{p} - ( n - 1 )} Z ( m - n ) {Z}^{*} ( i ) & \\ From 4 {T}_{clk} to 11 {T}_{clk} \text{:} ( ( 2 m + r ) + 2 ) & \\ {T}_{clk} \text{:} m \text{?} n = 1 \text{?} 2 \text{?} 3 \text{?} 4 \text{?} r = 0 \text{?} 1 & \\ ACn \text{:} R ( ( n - 4 r ) - 1 ) = {\sum }_{i = 0}^{- n - 8} \frac{1}{{L}_{p} - ( ( n - 4 r ) - 1 )} Z ( ( m - n - 4 r ) - 4 ) {Z}^{*} ( i ) & \\ From 12 {T}_{clk} to 65 {T}_{clk} \text{:} ( ( 3 m + r ) + 9 ) & \\ {T}_{clk} \text{:} m = 1 \text{?} 2 \text{?} … \text{?} 18 \text{?} r = 0 \text{?} 1 \text{?} 2 \text{?} n = 1 \text{?} 2 \text{?} 3 \text{?} 4 & \\ ACn \text{:} R ( ( n - 4 r ) - 1 ) = {\sum }_{i = - n - 9}^{- n - 1} \frac{1}{{L}_{p} - ( ( n - 4 r ) - 1 )} Z ( ( m - n - 4 r ) - 8 ) {Z}^{*} ( i ) \\ \text{?} \text{indicates text missing or illegible when filed} & \end{matrix}$$

Here, ACn represents each of the autocorrelators 141, 142, 143, and 144 in FIG. 4. Each of the autocorrelators 141, 142, 143, and 144 performs an autocorrelation operation at an operation cycle designated by scheduling shown in FIG. 6. Additionally, autocorrelation values calculated in each cycle are stored in a corresponding result value registers R0 to R11 via the DEMUX network 145.

The third unit 160 includes a phase difference operation block for calculating a phase difference between five adjacent symbols, a smoothing function, five multipliers 171, 172, 173, 174, and 175 for multiplying Iₖ, and three adders 176, 177, and 178.

The phase shift operation blocks 161, 162, 163, 164, and 165 include an arctangent operator for converting an estimation value of a vector into an estimation value of a phase. The phase shift operation blocks 161, 162, 163, 164, and 165 sequentially uses values stored in each of the autocorrelation result value registers R0 to R11 of the second unit 140 to calculate a phase difference between adjacent symbols. For example, a phase difference between R0 and R1, R4 and R5, and R8 and R9 is calculated for three cycles in the same phase difference operation block 162. Next, the smoothing function corresponding to the calculated value is performed and Iₖ is multiplied. An accumulator 179 calculates an initial frequency estimation value fe by performing the smoothing function and adding values multiplied by Iₖ.

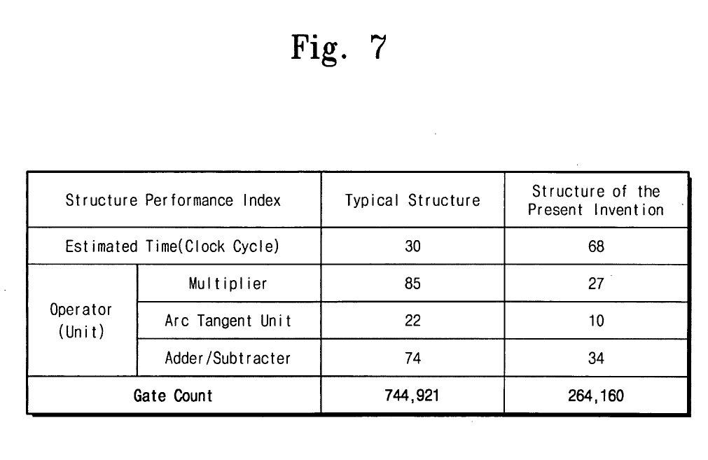

FIG. 7 is a table illustrating performance comparison between a typical frequency estimator and a frequency estimator of the present invention. Referring to FIG. 7, a time for estimating an initial frequency error requires 30 clock cycles in the typical structure, but 68 clock cycles in the structure of the present invention. As illustrated in FIG. 2, compared to the frequency estimation method in the suggested structure, the estimation operation is performed at an entire interval of the PLHEADER. Therefore, clock cycles are more required compared to the typical structure. However, in an aspect of hardware complexity, the structure of the present invention have 58 less multipliers, 12 less arctangent operators, and 40 less adders and subtracters compared to the typical structure. Accordingly, the hardware complexity of the initial frequency error estimators according to the present invention can be reduced by about 64.5%.

The present invention realizes an estimation method using SOF in order to effectively estimate an initial frequency error in a DVB-S2 system without utilizing a pilot column and a low complexity frequency error estimator structure based on M&M algorithm, in order to execute the estimation method. Therefore, according to the present invention, frequency error can be estimated without difficulties while consuming less power compared to the typical frequency error estimator having high hardware complexity. Additionally, the estimator structure of the present invention controls the number of autocorrelators such that another frequency estimator using a data-aided algorithm method can be realized with low complexity.

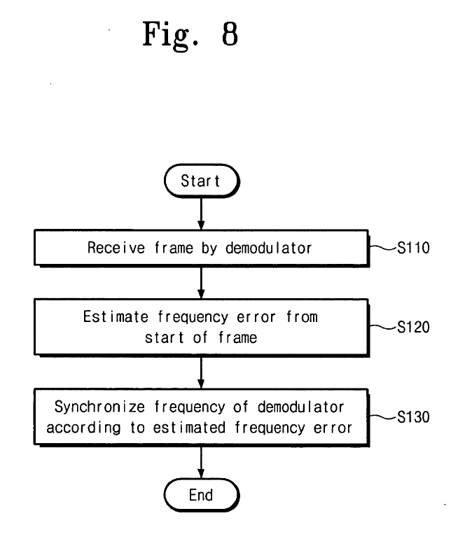

FIG. 8 is a flowchart illustrating a frequency synchronization method according to the present invention. Referring to FIG. 8, the frequency synchronization method will proceed as follows.

In operation S110, a demodulator (not shown) receives a frame. In operation S120, a frequency error estimator of the demodulator estimates a frequency error from the SOF of the received frame. This frequency estimation method is described with reference to FIGS. 1 through 7. In operation S130, the demodulator synchronizes frequency of the demodulators according to the estimated frequency error.

In the DVB-S2 according to the present invention, in order to efficiently estimate an initial frequency error, provided are an estimation method using the SOF and a low complexity frequency error estimator structure based on an M&M algorithm for executing the estimation method. Therefore, the frequency error estimator of the present invention makes it possible to estimate frequency errors with lower power consumption, compared to a typical frequency error estimator having a high hardware complexity.

Additionally, the frequency error estimator according to the present invention adjusts the number of autocorrelators and thus can realize other low complexity frequency estimators using a data-aided algorithm method.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A frequency error estimating method of a communication system, the method comprising:
receiving a frame; and
calculating a frequency error from a start of frame (SOF) field of the received frame.

2. The method of claim 1, wherein the frequency error is calculated while a physical layer header of the frame is received.

3. The method of claim 1, wherein the calculating of the frequency error comprises:
multiplying a plurality of symbols of the SOF field by training symbols for estimating errors in order for outputting result values;
calculating each autocorrelation value from the outputted result values;
calculating phase differences between adjacent symbols from the calculated autocorrelation value; and
calculating frequency errors from the calculated phase differences.

4. The method of claim 1, wherein the calculating of the frequency error uses a data-aided algorithm.

5. The method of claim 1, wherein the frame is set by a digital video broadcasting via satellite, second generation (DVB-S2) standard.

6. A frequency error estimator comprising:
a first-in-first-out (FIFO) memory storing values obtained by multiplying a plurality of SOF symbols in a received frame by training symbols used for estimating errors;
a tap delay outputting the values stored in the FIFO memory according to scheduling in synchronization with a first clock and storing the outputted values in first registers;
a plurality of autocorrelators outputting the values stored in the first registers in synchronization with a second clock, and calculating autocorrelation value from the outputted values;
second registers storing the calculated autocorrelation value;
a phase difference calculation block calculating a phase difference between adjacent symbols from the values stored in the second registers; and
an adder calculating a frequency error by adding the calculated phase differences.

7. The frequency error estimator of claim 6, wherein the number of the SOF symbols is 26, and the number of the first registers is 11.

8. The frequency error estimator of claim 7, wherein the number of the autocorrelators is 4.

9. The frequency error estimator of claim 6, wherein the frequency error is calculated until a physical layer symbol of the received frame is received.

10. The frequency error estimator of claim 6, wherein the received frame is a frame set by a DVB-S2.
